(19) United States
(12) Patent Application Publication
(10) Pub. No.: US 2009/0291839 A1
(43) Pub. Date: Nov. 26, 2009

(54) HONEYCOMB STRUCTURE

(75) Inventors: Masafumi KUNIEDA, Ibi-Gun (JP); Ken Yoshimura, Ibi-Gun (JP); Shinnosuke Goto, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/346,610

(22) Filed: Dec. 30, 2008

(30) Foreign Application Priority Data
May 20, 2008 (JP) PCT/JP2008/059261

(51) Int. Cl. B32B 3/12; B01J 29/00

(52) U.S. Cl. 502/74; 428/116; 502/60

(57) ABSTRACT

A honeycomb structure includes at least one honeycomb unit. In a pore distribution curve, the at least one honeycomb unit has one or more peak values of the log differential pore volume in a pore diameter range from about 0.006 μm to 0.06 μm and greater than 0.06 μm and less than or equal to about 1 μm. A volume of pores having diameters in a range from a peak pore diameter minus 0.03 μm to plus 0.03 μm is from about 60% to about 95% of a volume of pores having diameters greater than 0.06 μm and less than or equal to about 1 μm. The peak pore diameter corresponds to a highest one of the peak values of the log differential pore volume in the pore diameter range greater than 0.06 μm and less than or equal to about 1 μm.

### CROSS-REFERENCE TO RELATED APPLICATIONS

The present application claims priority under 35 U.S.C. §119 to PCT/JP2008/059261 filed on May 20, 2008, the entire contents of which are incorporated herein by reference.

### BACKGROUND OF THE INVENTION

1. Field of the Invention

The present invention relates to a honeycomb structure.

2. Description of the Related Art

Various technologies have been developed for converting automotive exhaust gases. However, with ever-growing traffic volumes, emission control measures currently being taken are hardly enough. In Japan and throughout the world, automotive emission control is expected to become stricter. Especially, regulation of NOx in diesel exhaust gases is becoming very strict. Conventionally, NOx reduction has been achieved by controlling combustion systems of engines. However, it is no longer possible to sufficiently reduce NOx solely by controlling combustion systems. To cope with this problem, a NOx-reduction system (called a selective catalytic reduction (SCR) system) using ammonia as a reducing agent has been proposed as a diesel NOx control system.

WO2005/063653 discloses a honeycomb structure used as a catalyst carrier in such a system. The disclosed honeycomb structure is produced by combining honeycomb units. Each of the honeycomb units is made by mixing γ-alumina, ceria, zirconia, zeolite, and the like with inorganic fibers and a binder for improving the strength, molding the mixture into a honeycomb shape, and firing the molded mixture. Thus, the disclosed honeycomb structure has improved strength that is an important factor for a catalyst carrier used for vehicles.

Also, WO2006/070540 discloses a honeycomb structure used as a catalyst carrier for vehicles. The disclosed honeycomb structure has a pore distribution that shows peaks in a pore diameter range between 0.006 μm and 0.01 μm corresponding to micropores and in a pore diameter range between 0.05 μm and 150 μm corresponding to macropores. The pores increase contact areas of NOx-occluding materials and catalytic components with exhaust gases.

The entire contents of WO2005/063653 and WO2006/070540 are incorporated herein by reference.

### SUMMARY OF THE INVENTION

According to an aspect of the present invention, a honeycomb structure includes at least one honeycomb unit. The honeycomb unit includes zeolite, an inorganic binder and cell walls defining cells extending along the longitudinal direction of the honeycomb unit from one end face to the other end face. In a pore distribution curve where the horizontal axis represents pore diameter and the vertical axis represents log differential pore volume, the honeycomb unit has one or more peak values of the log differential pore volume in a pore diameter range from about 0.006 μm to 0.06 μm and has one or more peak values of the log differential pore volume in a pore diameter range greater than 0.06 μm and less than or equal to about 1 μm. In the honeycomb unit, a volume of pores having diameters in a range from a peak pore diameter minus 0.03 μm to the peak pore diameter plus 0.03 μm is from about 60% to about 95% of a volume of pores having diameters greater than 0.06 μm and less than or equal to about 1 μm. The peak pore diameter corresponds to the highest one of the peak values of the log differential pore volume in the pore diameter range greater than 0.06 μm and less than or equal to about 1 μm.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a perspective view of a honeycomb structure including multiple honeycomb units according to an embodiment of the present invention;

FIG. 1B is a perspective view of a honeycomb structure including one honeycomb unit according to an embodiment of the present invention;

FIG. 2 is a perspective view of a honeycomb unit used for the honeycomb structure of FIG. 1A;

FIG. 3 is a graph showing a pore distribution curve of cell walls of a honeycomb unit of example 1; and

FIG. 4 is a graph showing relationships between the sharpness of macropores and the bending strength of honeycomb units of examples and comparative examples.

### DESCRIPTION OF THE PREFERRED EMBODIMENTS

Embodiments will now be described with reference to the accompanying drawings, wherein like reference numerals designate corresponding or identical elements throughout the various drawings.

Here, when zeolite is used as the main material of the honeycomb units of the honeycomb structure disclosed in WO2005/063653 and the honeycomb units are manufactured by molding and firing, the strength of the honeycomb units may become insufficient if the amount of zeolite is increased. A honeycomb structure made of such weak honeycomb units may not be able to maintain its function as a NOx-reduction catalyst carrier for automotive exhaust gases.

In the case of the honeycomb structure disclosed in WO2006/070540, if the peaks in the pore distribution become broad, the strength of the honeycomb structure becomes insufficient to be used as a NOx-reduction catalyst carrier for automotive exhaust gases.

Embodiments of the present invention make it possible to provide a honeycomb structure having enough strength and catalyst supporting capability to be mounted on a vehicle as an automotive-exhaust-gas conversion catalyst carrier.

Preferred embodiments of the present invention are described below with reference to the accompanying drawings.

The inventors of the present invention examined what causes the strength of a honeycomb structure using zeolite as its main material to become low. According to the examination, it is supposed that the bond between zeolite particles caused by dehydration condensation reaction is insufficient. Because zeolite particles contain a smaller amount of hydroxyl groups compared with inorganic oxide materials such as alumina, zeolite particles are less likely to show dehydration condensation reaction that increases the strength.

The inventors searched for a method to obtain a honeycomb structure with sufficient strength even when zeolite is used as its main material. The strength of a honeycomb structure can be effectively improved by increasing the contact areas of fine particles with each other and by causing the fine particles to uniformly contact each other. The result of increasing the contact areas of fine particles and causing the fine particles to uniformly contact each other appears in the pore distribution of cell walls. Therefore, the inventors examined cell wall pore distributions of honeycomb units to obtain honeycomb units with superior strength and thereby to produce a honeycomb structure with improved strength.

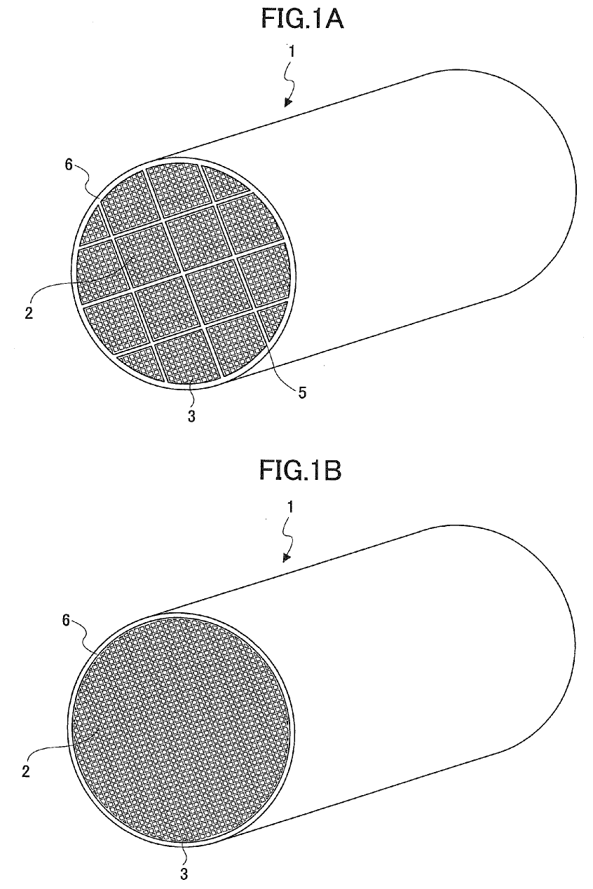

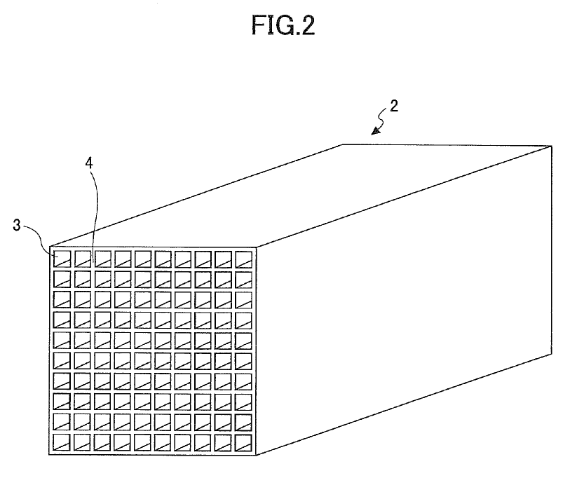

A honeycomb structure according to an embodiment of the present invention includes one or more honeycomb units each of which is a fired body including cell walls that define multiple cells extending along a longitudinal direction from one end face to the other end face. FIG. 1A is a perspective view of an exemplary honeycomb structure. A honeycomb structure 1 shown in FIG. 1A includes multiple honeycomb units 2 that are bonded together by interposing an adhesive 5. Each of the honeycomb units 2 is formed such that cells 3 are arranged parallel to the longitudinal direction of the honeycomb unit. FIG. 1B is a perspective view of another exemplary honeycomb structure. A honeycomb structure 1 shown in FIG. 1B includes one honeycomb unit 2. Thus, the honeycomb structure 1 may include either one honeycomb unit 2 or multiple honeycomb units 2. The side (the surface without cell openings) of the honeycomb structure 1 is preferably covered by an external wall 6 made of a coating layer to increase the strength. As exemplified by a perspective view of FIG. 2, the honeycomb unit 2 of the honeycomb structure 1 includes multiple cell walls 4 that define multiple cells 3 extending along the longitudinal direction of the honeycomb unit 2.

### (Pore Structure of Cell Walls of Honeycomb Unit)

In a pore distribution curve where the horizontal axis represents the pore diameter (μm) and the vertical axis represents the log differential pore volume (cm³/g), the honeycomb unit 2 of the embodiment of the present invention has one or more peak values of the log differential pore volume in a pore diameter range between about 0.006 μm and 0.06 μm and also has one or more peak values of the log differential pore volume in a pore diameter range greater than 0.06 μm and less than or equal to about 1 μm. Also, in the honeycomb unit 2, the volume of pores having diameters in a range plus or minus 0.03 μm of a pore diameter corresponding to the highest one of the peak values of the log differential pore volume in the pore diameter range greater than 0.06 μm and less than or equal to about 1 μm, amounts to about 60% to about 95% of the volume of pores having diameters greater than 0.06 μm and less than or equal to about 1 μm. Preferably, the peak values of the log differential pore volume in the pore diameter range greater than 0.06 μm and less than or equal to about 1 μm are present in a pore diameter range greater than 0.06 μm and less than or equal to about 0.1 μm.

Generally, when a catalyst carrier or a catalyst is produced by firing zeolite or inorganic particles, micropores, which are caused mainly by primary particles and have diameters less than or equal to about 0.06 μm, and macropores, which are caused mainly by gaps generated when secondary particles combine with each other and have diameters greater than or equal to about 0.06 μm, are formed in the fired body (hereafter, pores of cell walls having diameters between about 0.006 μm and 0.06 μm are called micropores and pores of cell walls having diameters greater than 0.06 μm and less than or equal to about 1 μm are called macropores).

The amount of catalyst material and the balance between micropores that serve as reaction sites and macropores that allow exhaust gases to penetrate into the inside of cell walls are thought to be important factors that determine exhaust gas conversion performance. One possible way to improve the strength of a honeycomb unit is to add inorganic fibers to the material while maintaining the exhaust gas conversion performance. However, although inorganic fibers contribute to the improvement of the strength, they are not thought to contribute to the exhaust gas conversion performance. In the embodiment of the present invention, honeycomb units with improved strength are produced by adjusting the pore distribution of fired bodies and a honeycomb structure is produced by using those honeycomb units.

The sharpness of macropores of a honeycomb unit is preferably between about 60% and about 95%. Adjusting the sharpness of macropores to between about 60% and about 95% makes it easier to improve the strength of a honeycomb unit.

### (Materials of Fired Body)

A honeycomb unit of the embodiment of the present invention preferably includes zeolite and an inorganic binder and may also include inorganic fibers. Below, components of a honeycomb unit and their materials are described.

### (Zeolite)

Zeolite is bound by an inorganic binder. Zeolite functions as a NOx-reduction catalyst as well as an ammonia gas adsorbent. Therefore, zeolite is an essential component of a honeycomb structure of the embodiment of the present invention, i.e., as an exhaust gas NOx-reduction catalyst in a urea SCR system. Any kind of zeolite may be used as long as it has desired catalytic ability and ammonia gas adsorption ability. Examples of zeolites include β-zeolite, Y-zeolite, ferrierite, ZSM-5 zeolite, mordenite, faujasite, zeolite A, and zeolite L. Also, a zeolite that is ion-exchanged in advance may be used. Further, a zeolite may be ion-exchanged after formed into a honeycomb unit. A zeolite ion-exchanged by at least one of metal species including Cu, Fe, Ni, Zn, Mn, Co, Ag, and V is preferably used. The above zeolites may be used individually or in combination.

The molar ratio between silica and alumina (silica/alumina ratio) of zeolite is preferably between 1 and 100. The silica/alumina ratio affects the acidity of zeolite, i.e., the adsorption and reactivity of reactive molecules. Therefore, the silica/alumina ratio is preferably determined according to the purpose.

The content of zeolite per unit apparent volume of a honeycomb unit is preferably between about 230 g/L and about 700 g/L. In other words, the content of zeolite in a honeycomb unit is preferably between about 60 mass % and about 80 mass %. The catalytic and adsorption abilities of zeolite normally increase as the content of zeolite in a honeycomb structure increases. However, just increasing the content of zeolite may make it necessary to decrease the contents of other components (such as inorganic fibers and inorganic binder) and therefore decreases the strength of a fired honeycomb unit.

Zeolite preferably includes secondary particles and the average diameter of secondary particles of zeolite is preferably between about 0.5 μm and about 10 μm. The average diameter of secondary particles may be measured by using zeolite particles as raw material forming the secondary particles before the particles are fired to form a honeycomb unit.

### (Inorganic Binder)

As the inorganic binder, for example, an inorganic sol, a clay binder, or the like may be used. Examples of inorganic sols include alumina sol, silica sol, titania sol, sepiolite sol, attapulgite sol, and water glass. Examples of clay binders include terra alba, kaolin, montmorillonite, and multiple chain structure clay (e.g., sepiolite and attapulgite). The above inorganic sols and clay binders may be used individually or in combination. The solid content of inorganic binder in a honeycomb unit is preferably between about 5 mass % and about 30 mass % and more preferably between about 10 mass % and about 20 mass %. If the content of inorganic binder is out of the range between about 5 mass % and about 30 mass %, the moldability may be reduced.

### (Inorganic Fibers)

A honeycomb unit of a honeycomb structure of the embodiment of the present invention may also include inorganic fibers. As the inorganic fibers used for a honeycomb unit, for example, any one of or a combination of alumina fibers, silica fibers, silicon carbide fibers, silica-alumina fibers, glass fibers, potassium titanate fibers, aluminum borate fibers, and the like may be used. The inorganic fibers are mixed with zeolite and an inorganic binder, and the mixture of materials is molded and fired to form a honeycomb unit. The inorganic fibers together with the inorganic binder and zeolite form a fiber-reinforced fired body and make it easier to improve the strength of the honeycomb unit. Here, inorganic fibers include not only long fibers but also short fibers such as whiskers.

Inorganic fibers are inorganic materials having a high aspect ratio (fiber length/fiber diameter) and are thought to improve particularly the bending strength. The aspect ratio of inorganic fibers is preferably between about 2 and about 1000, more preferably between about 5 and about 800, and still more preferably between about 10 and about 500. If the aspect ratio of inorganic fibers is greater than or equal to about 2, the effect of improving the strength of the honeycomb unit may not become insufficient. On the other hand, if the aspect ratio of inorganic fibers is less than or equal to about 1000, the inorganic fibers may not cause clogging of a die for molding and may not reduce the moldability. Also, inorganic fibers with such a high aspect ratio may not easily break during molding operations such as extrusion molding, and as a result, the fiber lengths may not become inconsistent and the strength of the honeycomb unit may not be reduced. If the inorganic fibers have various aspect ratios, an average value of the aspect ratios may be used.

The content of inorganic fibers in a honeycomb unit is preferably between about 3 mass % and about 50 mass %, more preferably between about 3 mass % and about 30 mass %, and still more preferably between about 5 mass % and about 20 mass %. If the content of inorganic fibers is greater than or equal to about 3 mass %, the strength of the honeycomb structure may not be reduced. On the other hand, if the content of inorganic fibers becomes less than or equal to about 50 mass %, the proportion of zeolite, which serves as a NOx-reduction catalyst, may not decrease and the NOx-conversion performance of the honeycomb structure may not be reduced.

### (Inorganic Particles)

A honeycomb unit of a honeycomb structure of the embodiment of the present invention may also include inorganic particles other than zeolite particles. Inorganic particles are thought to improve the strength of a honeycomb unit. Examples of inorganic particles other than zeolite particles usable for a honeycomb unit of a honeycomb structure of the embodiment of the present invention include, but are not limited to, alumina, silica, zirconia, titania, ceria, mullite, and their precursors. Particularly, alumina and zirconia are preferable. As alumina, γ-alumina or boehmite is preferably used. The above inorganic particles other than zeolite particles may be used individually or in combination.

Before being fired, as are most of industrially-available inorganic compound particles, inorganic particles and zeolite particles as raw material in a honeycomb unit of the embodiment of the present invention include hydroxyl groups. The hydroxyl groups are thought to cause dehydration condensation reaction when a honeycomb unit is fired and thereby to strengthen the bond between the particles. Particularly, inorganic particles such as alumina particles as raw material are thought to be firmly bonded by dehydration condensation reaction during firing.

In a honeycomb structure of the embodiment of the present invention, the average diameter of secondary particles of inorganic particles other than zeolite particles as raw material is preferably less than or equal to the average diameter of secondary particles of zeolite particles. More specifically, the average diameter of inorganic particles other than zeolite particles is preferably between about 1/10 and about 1/1 of the average diameter of zeolite particles. Using inorganic particles other than zeolite particles having such a small average diameter makes it easier to improve the strength of a honeycomb unit by the bonding force of the inorganic particles.

The content of inorganic particles other than zeolite particles in a honeycomb unit is preferably between about 3 mass % and about 30 mass % and more preferably between about 5 mass % and about 20 mass %. If the content of inorganic particles other than zeolite particles is greater than or equal to about 3 mass %, the contribution of the inorganic particles to the strength of the honeycomb unit may not become small. Meanwhile, if the content of inorganic particles other than zeolite particles is less than or equal to about 30 mass %, the proportion of zeolite, which serves as a NOx-reduction catalyst, may not decrease and the NOx-conversion performance of the honeycomb unit may not be reduced.

### (Catalytic Component)

The cell walls of a honeycomb unit of a honeycomb structure of the embodiment of the present invention may also support a catalytic component. Examples of catalytic components include, but are not limited to, noble metals, alkali metal compounds, and alkaline-earth metal compounds. As noble metals, for example, any one of or a combination of platinum, palladium, and rhodium may be used. As alkali metal compounds, for example, any one of or a combination of potassium compounds, sodium compounds, and the like may be used. As alkaline-earth metal compounds, for example, barium compounds or the like may be used.

### (Honeycomb Structure)

A plane orthogonal to the longitudinal direction of cells (hereafter, simply called a cross section) of a honeycomb unit of a honeycomb structure of the embodiment of the present invention may have a square shape, a rectangular shape, a hexagonal shape, or a fan-like shape.

FIGS. 1A and 1B show exemplary honeycomb units. The honeycomb unit 2 includes cell walls 4 defining cells 3 extending from left to right (from the near side to the far side). The thickness of the cell walls 4 is preferably, but is not limited to, between about 0.10 mm and about 0.50 mm and more preferably between about 0.15 mm and about 0.35 mm. If the thickness of the cell walls 4 is greater than or equal to about 0.10 mm, the strength of the honeycomb unit may not become insufficient. If the thickness of the cell walls 4 is less than or equal to about 0.50 mm, the exhaust gas may easily penetrate into the cell walls 4 and as a result, the exhaust gas conversion performance may not become insufficient. The opening ratio, which indicates an area ratio of cells of a honeycomb unit in a cross section orthogonal to the cells, is preferably between about 40% and about 80%. An opening ratio of about 40% to about 80% is preferable to make it easier to keep the pressure loss below a certain level while maintaining the volume of cell walls, which serve as catalytic component carriers, above a certain level.

The number of cells per unit cross-sectional area of the honeycomb unit is preferably between about 15.5 cells/cm² and about 93 cells/cm² (about 100 to about 600 cpsi), and more preferably between about 31 cells/cm² and about 77.5 cells/cm² (about 200 to about 500 cpsi).

The cross sections of the cells 3 of the honeycomb unit may have any shape. Although the cross sections of the cells 3 shown in FIG. 2 have a square shape, the cross sections of the cells 3 may have any other shape such as a substantially-triangular shape, a substantially-hexagonal shape, or a circular shape.

### (Production of Honeycomb Unit)

An exemplary method of producing a honeycomb unit of a honeycomb structure of the embodiment of the present invention is described below. First, a raw material paste including zeolite and an inorganic binder as main components is prepared. The raw material paste is extrusion-molded into a honeycomb unit molded body. The raw material paste may also include inorganic fibers, inorganic particles, an organic binder, a dispersion medium, and/or a molding aid. As the organic binder, for example, any one of or a combination of methylcellulose, carboxymethylcellulose, hydroxyethylcellulose, polyethylene glycol, phenolic resin, epoxy resin, and the like may be used. The amount of organic binder is preferably between about 1% and about 10% of the total mass (100%) of the solid content of all the materials. As the dispersion medium, for example, water, an organic solvent (such as toluene), an alcohol (such as methanol), or the like may be used. As the molding aid, for example, ethylene glycol, dextrin, fatty acid soap, polyalcohol, or the like may be used.

The raw material paste is preferably prepared by mixing the raw materials using a mixer, an attritor, or the like and by kneading the mixture using a kneader or the like. The raw material paste is preferably molded into a shape having cells, for example, by extrusion molding or the like.

Next, the obtained honeycomb unit molded body is dried using a drying apparatus such as a microwave drying apparatus, a hot-air drying apparatus, a dielectric drying apparatus, a reduced pressure drying apparatus, a vacuum drying apparatus, or a freeze drying apparatus. The dried honeycomb unit molded body is preferably degreased. Although degreasing conditions may be determined freely depending on the kinds and amounts of organic materials in the honeycomb unit molded body, degreasing is preferably performed at about 400° C. for about two hours. Then, the dried and degreased honeycomb unit molded body is fired. The firing temperature is preferably between about 600° C. and about 1200° C. and more preferably between about 600° C. and about 1000° C. If the firing temperature is greater than or equal to about 600° C., sintering may proceed smoothly and the strength of the honeycomb unit may become sufficient. If the firing temperature is less than or equal to about 1200° C., zeolite crystals may not easily collapse and sintering may not proceed too far, and it may become easier to produce a porous honeycomb unit.

### (Production of Honeycomb Structure)

An exemplary method of producing a honeycomb structure including multiple honeycomb units is described below. An adhesive is applied to the sides of honeycomb units produced as described above and the honeycomb units are bonded together. Next, the adhesive is solidified by drying to produce a honeycomb unit bonded body having a predetermined size. The honeycomb unit bonded body is formed into a desired shape by cutting its sides.

As the adhesive, for example, a mixture of an inorganic binder and inorganic particles; a mixture of an inorganic binder and inorganic fibers; a mixture of an inorganic binder, inorganic particles, and inorganic fibers; or the like may be used. The adhesive may also include an organic binder. As the organic binder, for example, any one of or a combination of polyvinyl alcohol, methylcellulose, ethylcellulose, carboxymethylcellulose, and the like may be used.

The thickness of the adhesive layers for bonding the honeycomb units is preferably between about 0.5 mm and about 2 mm. The number of honeycomb units to be bonded may be determined freely depending on the size of a honeycomb structure to be produced. The honeycomb unit bonded body, which is made by bonding multiple honeycomb units by interposing an adhesive, may be cut and ground according to the shape of the honeycomb structure.

Then, a coating material is applied to the outer surface (the surface without cell openings) of the honeycomb unit bonded body and is solidified by drying to form a coating layer. The coating layer protects the outer surface of the honeycomb structure and improves the strength. The coating material may be made of the same materials as those of the adhesive or may be made of materials different from those of the adhesive. Also, the mixing ratio of materials of the coating material may be the same as or different from that of the adhesive. The thickness of the coating layer is preferably between about 0.1 mm and about 2 mm. The coating layer may be formed or may not be formed.

After bonding honeycomb units by interposing an adhesive, it is preferable to heat the honeycomb unit bonded body. In the case where the coating layer is formed, the honeycomb structure is preferably degreased after the adhesive layer and the coating layer are formed. Particularly, if the adhesive layer and/or the coating layer includes an organic binder, it is preferable to degrease the organic binder. Although degreasing conditions may be determined freely depending on the kinds and amounts of contained organic materials, degreasing is preferably performed at about 700° C. for about two hours.

FIG. 1A shows an exemplary honeycomb structure 1 having a cylindrical shape and formed by combining multiple honeycomb units 2 each of which is a rectangular pillar and has a square cross section. The honeycomb structure 1 is formed by bonding together the honeycomb units 2 using the adhesive 5, forming the bonded honeycomb units into a cylindrical shape by cutting the outer surface, and forming the coating layer 6 on the outer surface using a coating material. Alternatively, for example, the honeycomb structure 1 with a cylindrical shape may be formed by bonding honeycomb units 2 with fan-shaped and square-shaped cross sections. In this case, the cutting and grounding processes may be omitted.

Next, an exemplary method of producing a honeycomb structure including one honeycomb unit is described. In this case, a honeycomb unit is produced as described above and formed into a cylindrical shape, and a coating layer is formed on the outer surface of the honeycomb unit to produce the honeycomb structure. FIG. 1B shows an exemplary honeycomb structure including one honeycomb unit.

### EXAMPLES

The embodiment of the present invention is further described below in more detail by way of examples where honeycomb structures were produced by varying conditions. However, the present invention is not limited to the examples described below.

### EXAMPLE 1

### (Production of Honeycomb Unit)

The following materials were mixed: 2250 mass parts of zeolite particles (Fe ion-exchanged β-zeolite, silica/alumina ratio: 40, specific surface area: 110 m²/g, average particle diameter: 2 μm (average particle diameter of secondary particles)), 680 mass parts of alumina fibers (average fiber diameter: 6 μm, average fiber length: 100 μm), 2600 mass parts of alumina sol (solid content: 20 mass %), and 320 mass parts of methylcellulose used as an organic binder. Further, small amounts of a plasticizer, a surfactant, and a lubricant were added to the mixture. Then, the mixture was kneaded while adjusting its viscosity by adding water to obtain a mixed composition for molding. Next, the mixed composition was extrusion-molded using an extruder to obtain raw honeycomb unit molded bodies.

The honeycomb unit molded bodies were sufficiently dried using a microwave drying apparatus and a hot-air drying apparatus and then degreased at 400° C. for two hours. Then, the honeycomb unit molded bodies were fired at 700° C. for two hours. As a result, rectangular-pillar honeycomb units with a height of 35 mm, a width of 35 mm, and a length of 150 mm were obtained. The cells of the honeycomb units had a quadrangular (square) shape. The cell density was 93 cells/cm² and the thickness of the cell walls was 0.2 mm. The Fe ion-exchanged zeolite was prepared by impregnating zeolite particles with a ferric nitrate ammonium solution for Fe ion exchange. The amount of ion-exchange was measured by IPC emission analysis using ICPS-8100 (Shimadzu Corporation).

Table 1 shows specific surface areas, average particle diameters, and particle size distributions of zeolite particles used to produce honeycomb units of examples and comparative examples; peak values of the log differential pore volume of micropores of honeycomb unit fired bodies (micropore peak values); peak values of the log differential pore volume of macropores (macropore peak values), and the sharpness of macropores. The particle size distribution is an index indicating the spread of particle size distribution and is represented by {(D90−D10)/D50} where D is the diameter of zeolite particles. The sharpness of macropores is the ratio (percentage) of the volume of pores having diameters in a range plus or minus 0.03 μm of a pore diameter corresponding to the peak value of the log differential pore volume of macropores to the total volume of macropores. In example 1, each of the log differential pore volume of micropores and the log differential pore volume of macropores showed only one peak value.

TABLE 1

| | Zeolite (raw material) | | | After being fired | | | Cell structure | | | | |
|---|---|---|---|---|---|---|---|---|---|---|---|
| | Specific | Average | | Micropore | Macropore | | Cell | Wall | | | Evaluation |
| | surface | particle | Particle | peak | peak | Macropore | density | thick- | Opening | Carrier | Bending |
| | area | diameter | size | value | value | sharpness | (cells/ | ness | ratio | weight | strength |
| | (m²/g) | (μm) | distribution | (μm) | (μm) | (%) | cm²) | (mm) | (%) | (g/L) | (MPa) |
| Example 1 | 110 | 2 | 2.2 | 0.008 | 0.08 | 80 | 0.2 | 93 | 64.1 | 381 | 8.4 |
| Example 2 | 110 | 2 | 1.8 | 0.008 | 0.07 | 95 | 0.2 | 93 | 64.1 | 385 | 8.7 |
| Example 3 | 110 | 2 | 2.6 | 0.008 | 0.09 | 60 | 0.2 | 93 | 64.1 | 382 | 8.2 |
| Example 4 | 110 | 4 | 2.2 | 0.008 | 0.10 | 76 | 0.2 | 93 | 64.1 | 380 | 7.0 |
| Example 5 | 80 | 2 | 2.2 | 0.010 | 0.08 | 73 | 0.2 | 93 | 64.1 | 382 | 7.2 |
| Example 6 | 130 | 2 | 2.2 | 0.006 | 0.08 | 75 | 0.2 | 93 | 64.1 | 385 | 8.5 |
| Example 7 | 110 | 2 | 1.8 | 0.008 | 0.07 | 95 | 0.2 | 124 | 60.6 | 451 | 10.2 |
| Example 8 | 110 | 4 | 2.2 | 0.008 | 0.10 | 76 | 0.2 | 124 | 60.6 | 455 | 8.6 |
| Comparative | 110 | 10 | 2.8 | 0.008 | 0.22 | 46 | 0.2 | 93 | 64.1 | 382 | 4.2 |
| example 1 | | | | | | | | | | | |
| Comparative | 110 | 2 | 3.5 | 0.008 | 0.09 | 56 | 0.2 | 93 | 64.1 | 384 | 4.6 |
| example 2 | | | | | | | | | | | |

Table 1 also shows cell structures, opening ratios, carrier weights, and bending strength of obtained honeycomb units. The bending strength of honeycomb units was measured according to three-point bending test (JIS R 1601). The measurement was performed using Instron 5582 as the measurement apparatus by applying a breaking load W to the cell walls in the vertical direction with a span L of 135 mm and a crosshead speed of 1 mm/min. The bending strength a was calculated according to the following formula where a second moment Z of the cross section was obtained by subtracting the moment of cavities of cells:

σ=WL/4Z

The entire contents of JIS R 1601 is incorporated herein by reference.

### (Production of Honeycomb Structure)

An adhesive paste was applied to the sides of the produced honeycomb units to form an adhesive layer with a thickness of 1 mm. Then, four rows and four columns of the honeycomb units were bonded together and solidified by drying at 120° C. to form a honeycomb unit bonded body with a substantially rectangular shape. The adhesive paste was prepared by mixing 29 mass % of alumina particles (average particle diameter: 2 μm), 7 mass % of alumina fibers (average fiber diameter: 6 μm, average fiber length: 100 μm), 34 mass % of alumina sol (solid content: 20 mass %), 5 mass % of carboxymethyl cellulose, and 25 mass % of water. The produced honeycomb unit bonded body was formed into a cylindrical shape by cutting its side walls using a diamond cutter. Then, a coating material paste (same as the adhesive paste) was applied to the outer surface of the cylindrical honeycomb unit bonded body to form a coating layer with a thickness of 0.5 mm. The produced cylindrical honeycomb unit bonded body had substantially the same shape as that shown in FIG. 1A. The cylindrical honeycomb unit bonded body was solidified by drying at 120° C. and kept in a temperature of 700° C. for two hours to degrease the adhesive layer and the coating layer. As a result, a cylindrical honeycomb structure with a diameter of about 144 mm and a length of about 150 mm was obtained.

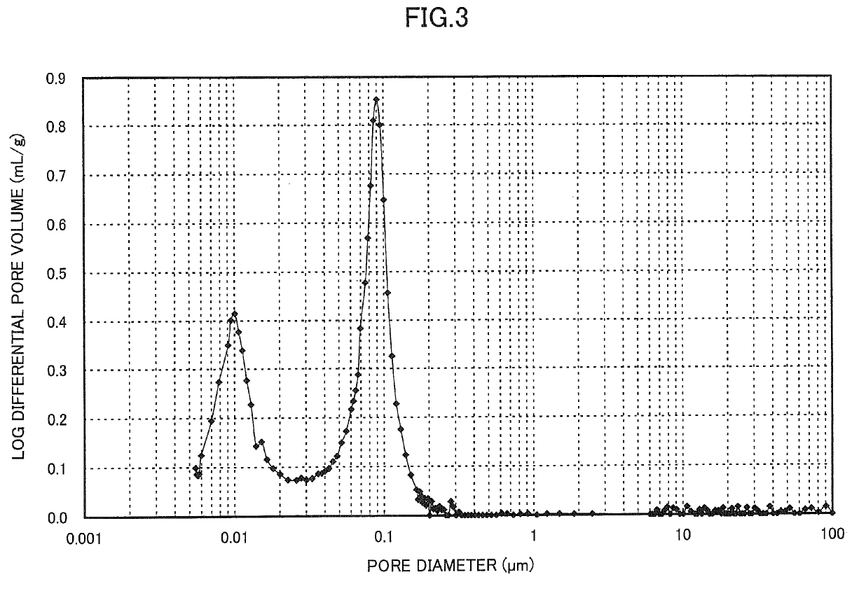

FIG. 3 shows a pore distribution curve of cell walls of the honeycomb unit of example 1 where the horizontal axis represents the pore diameter (μm) and the vertical axis represents the log differential pore volume (cm³/g). As shown by the pore distribution curve of FIG. 3, the honeycomb unit of example 1 has one peak value of the log differential pore volume in a pore diameter range between 0.006 μm and 0.06 μm and also has one peak value of the log differential pore volume in a pore diameter range greater than 0.06 μm and less than or equal to 0.1 μm.

### Examples 2-8 and Comparative Example 1 and 2

### (Production of Honeycomb Unit)

Honeycomb units of examples 2-8 and comparative examples 1 and 2 were produced in substantially the same manner as in example 1 except that zeolite particles with different specific surface areas, average particle diameters, and particle size distributions were used as shown in table 1. Characteristics of the produced honeycomb units are also shown in table 1.

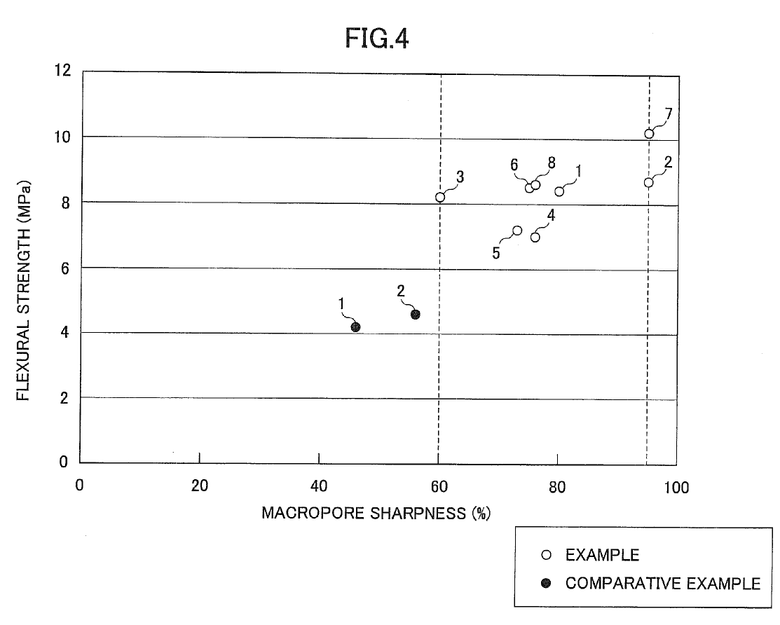

FIG. 4 is a graph showing relationships between the sharpness of macropores and the bending strength of honeycomb units. The horizontal axis represents the sharpness (%) of macropores of the honeycomb units and the vertical axis represents the bending strength (MPa) of the honeycomb units. In FIG. 4, ◯ indicates examples and indicates comparative examples, and the numbers attached to ◯ and indicate the numbers of the corresponding examples and comparative examples.

### (Evaluation Results)

As shown in table 1 and FIG. 4, all the honeycomb units of examples 1-8 and comparative examples 1 and 2 have micropores and macropores. The sharpness levels of macropores of honeycomb unit fired bodies of examples 1-8 were within a range between about 60% and about 95%. Meanwhile, the sharpness levels of macropores of honeycomb unit fired bodies of comparative examples 1 and 2 were 46% and 56%, respectively, and were out of the range between about 60% and about 95%. Accordingly, the bending strength levels of the honeycomb units of examples 1-8 were high in a range between 7 to 10.2 MPa, but the bending strength levels of the honeycomb units of comparative examples 1 and 2 were low at 4.2 MPa and 4.6 MPa. Thus, the honeycomb units of examples 1-8 are suitable for automotive-exhaust-gas conversion catalyst carriers.

A honeycomb structure according to embodiments of the present invention includes one or more honeycomb units with superior strength and therefore has enough strength to resist vibration when used as an automotive-exhaust-gas conversion catalyst carrier. Particularly, a honeycomb structure according to embodiments of the present invention is suitable for a NOx-reduction catalyst carrier used in a urea SCR system (a diesel exhaust gas conversion system using urea) that requires a zeolite catalyst.

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
at least one honeycomb unit having a longitudinal direction and comprising:
a zeolite;
an inorganic binder; and
cell walls defining cells extending along the longitudinal direction from one end face to another end face,
wherein, in a pore distribution curve where a horizontal axis represents a pore diameter and a vertical axis represents a log differential pore volume, the at least one honeycomb unit has one or more peak values of the log differential pore volume in a pore diameter range from about 0.006 μm to 0.06 μm and has one or more peak values of the log differential pore volume in a pore diameter range greater than 0.06 μm and less than or equal to about 1 μm, and
wherein a volume of pores having diameters in a range from a peak pore diameter minus 0.03 μm to the peak pore diameter plus 0.03 μm is from about 60% to about 95% of a volume of pores having diameters greater than 0.06 μm and less than or equal to about 1 μm, the peak pore diameter corresponding to a highest one of the peak values of the log differential pore volume in the pore diameter range greater than 0.06 μm and less than or equal to about 1 μm.

2. The honeycomb structure as claimed in claim 1, wherein the peak values of the log differential pore volume in the pore diameter range greater than 0.06 μm and less than or equal to about 1 μm are present in a pore diameter range greater than 0.06 μm and less than or equal to about 0.1 μm.

3. The honeycomb structure as claimed in claim 1, wherein the zeolite includes at least one of β-zeolite, Y-zeolite, ferrierite, ZSM-5 zeolite, mordenite, faujasite, zeolite A, and zeolite L.

4. The honeycomb structure as claimed in claim 1, wherein a molar ratio of silica to alumina (silica/alumina ratio) of the zeolite is from about 1 to about 100.

5. The honeycomb structure as claimed in claim 1, wherein a content of the zeolite per liter of apparent volume of the at least one honeycomb unit is from about 230 g to about 700 g.

6. The honeycomb structure as claimed in claim 1, wherein a content of the zeolite is from about 60 mass % to about 80 mass %.

7. The honeycomb structure as claimed in claim 1, wherein the zeolite includes secondary particles and an average diameter of the secondary particles is from about 0.5 μm to about 10 μm.

8. The honeycomb structure as claimed in claim 1, wherein the zeolite is ion-exchanged by at least one of Cu, Fe, Ni, Zn, Mn, Co, Ag, and V.

9. The honeycomb structure as claimed in claim 1, wherein the at least one honeycomb unit further includes inorganic fibers.

10. The honeycomb structure as claimed in claim 9, wherein the inorganic fibers include at least one of alumina fibers, silica fibers, silicon carbide fibers, silica-alumina fibers, glass fibers, potassium titanate fibers, and aluminum borate fibers.

11. The honeycomb structure as claimed in claim 1, wherein the inorganic binder includes at least one of alumina sol, silica sol, titania sol, water glass, sepiolite sol, and attapulgite sol.

12. The honeycomb structure as claimed in claim 1, wherein an opening ratio of the at least one honeycomb unit is from about 40% to about 80%.

13. The honeycomb structure as claimed in claim 1, wherein a thickness of the cell walls is from about 0.1 mm to about 0.5 mm.

14. The honeycomb structure as claimed in claim 1, wherein a catalytic component is provided on the cell walls.

15. The honeycomb structure as claimed in claim 14, wherein the catalytic component comprises at least one of a noble metal, an alkali metal compound, and an alkaline-earth metal compound.

16. The honeycomb structure as claimed in claim 1, wherein the honeycomb structure comprises a plurality of honeycomb units that are bonded together by providing an adhesive between the plurality of honeycomb units.

17. The honeycomb structure as claimed in claim 1, wherein the honeycomb structure comprises one honeycomb unit.

18. The honeycomb structure as claimed in claim 1, wherein a side of the honeycomb structure is covered by an outer wall made of a coating layer.

19. The honeycomb structure as claimed in claim 1, wherein the inorganic binder comprises at least one of an inorganic sol and a clay binder.

20. The honeycomb structure as claimed in claim 1, wherein a solid content of the inorganic binder in the at least one honeycomb unit is from about 5 mass % to about 30 mass %.

21. The honeycomb structure as claimed in claim 9, wherein an aspect ratio of the inorganic fibers is from about 2 to about 1000.

22. The honeycomb structure as claimed in claim 9, wherein a content of the inorganic fibers in the at least one honeycomb unit is from about 3 mass % to about 50 mass %.

23. The honeycomb structure as claimed in claim 1, wherein the at least one honeycomb unit further comprises inorganic particles other than the zeolite.

24. The honeycomb structure as claimed in claim 23, wherein the inorganic particles other than the zeolite in the at least one honeycomb unit comprise at lest one of alumina, silica, zirconia, titania, ceria, mullite, and their precursors.

25. The honeycomb structure as claimed in claim 23, wherein an average diameter of secondary particles of the inorganic particles other than the zeolite is less than or equal to an average diameter of secondary particles of the zeolite.

26. The honeycomb structure as claimed in claim 23, wherein an average diameter of the inorganic particles other than the zeolite is from about 1/10 to about 1/1 of an average diameter of the zeolite.

27. The honeycomb structure as claimed in claim 23, wherein a content of the inorganic particles other than the zeolite in the at least one honeycomb unit is from about 3 mass % to about 30 mass %.

28. The honeycomb structure as claimed in claim 1, wherein a number of cells per unit cross-sectional area of the at least one honeycomb unit is from about 15.5 cells/cm² to about 93 cells/cm².

29. The honeycomb structure as claimed in claim 1, wherein the honeycomb structure is so constructed to be used as an automotive-exhaust-gas conversion catalyst carrier.

30. The honeycomb structure as claimed in claim 1, wherein the honeycomb structure is so constructed to be used as a NOx-reduction catalyst carrier in a urea SCR system.
